(19) United States
(12) Patent Application Publication
(10) Pub. No.: US 2014/0078185 A1
(43) Pub. Date: Mar. 20, 2014

(54) SYSTEMS, DEVICES, AND METHODS FOR IMPROVING IMAGE QUALITY OF A DISPLAY

(71) Applicants: Chuan Pu, Foster City, CA (US); Yi Tao, San Jose, CA (US); Nageswara Rao Tadepalli, San Jose, CA (US)

(72) Inventors: Chuan Pu, Foster City, CA (US); Yi Tao, San Jose, CA (US); Nageswara Rao Tadepalli, San Jose, CA (US)

(21) Appl. No.: 13/616,700

(22) Filed: Sep. 14, 2012

(51) Int. Cl. G09G 5/10; B05D 5/06

(52) U.S. Cl. 345/690; 427/64

(57) ABSTRACT

This disclosure provides systems, methods and apparatus for writing data to a display. In one aspect, the display includes an array of display elements arranged at the intersection of a plurality of common lines and segment lines. The display also includes a common driver and a segment driver coupled to the common lines and segment lines. According to one aspect, the display includes a greater number of segment lines than columns of display elements in the array. According to another aspect, the display may also include a first number of display element segment electrodes that are coupled to each other along a first common line, and a second number of display element segment electrodes coupled to each other along a second common line, where the first number is different than the second number.

### TECHNICAL FIELD

This disclosure relates to methods and system for driving an array of display elements, such as an array of electromechanical display elements.

### DESCRIPTION OF THE RELATED TECHNOLOGY

Electromechanical systems include devices having electrical and mechanical elements, actuators, transducers, sensors, optical components (e.g., minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

In some display devices, display elements can include interferometric modulators. Interferometric modulators can be driven with a passive row and column driving scheme that writes image information sequentially into lines of display elements. To passively write data to an array having rows and columns of display elements, each row of display may be addressed with a write pulse to write data to a display element according to segment data that is applied to the display element. In a sequential driving scheme, a frame rate for passively writing data to an array of display elements is a function of the number of separately addressed rows of display elements.

### SUMMARY

The systems, methods and devices of the disclosure each have several innovative aspects, no single one of which is solely responsible for the desirable attributes disclosed herein.

In one implementation, a display apparatus is disclosed. The display apparatus can include a plurality of common lines and a plurality of segment lines. Each segment line can include a first data line and a second data line configured to apply different data signals. The display apparatus can further include a plurality of display elements. Each display element can be in electrical communication with one of the plurality of common lines and one of the plurality of segment lines. The connection between the first data line of a first segment line and a first set of display elements along the first segment line can be structurally different from the connection between the second data line of the first segment line and a second set of display elements along the first segment line. At least some of the structural differences can be positioned such that they do not cause substantial differences in visual appearance between display elements of the same color, or at least some of the structural differences can alternate at a rate such that any differences in visual appearance are not visually resolvable by a viewer.

In another implementation, a method of manufacturing a display is disclosed. The method can further include forming a plurality of segment lines. Each segment line can have a first data line and a second data line configured to apply different data signals. The method can also include forming a first connection between the first data line of a first segment line and a first set of display elements along the first segment line. Furthermore, the method can include forming a second connection between the second data line of the first segment line and a second set of display elements along the first segment line. The second connection can be structurally different from the first connection. At least some of the structural differences can be positioned such that they do not cause substantial differences in visual appearance between display elements of the same color, or at least some of the structural differences can alternate at a rate such that any differences in visual appearance are not visually resolvable by a viewer.

In yet another implementation, a display apparatus is disclosed. The display apparatus can include a plurality of common lines. The display apparatus can also include a plurality of segment lines. Each segment line can include a first data line and a second data line configured to apply different data signals. The display apparatus can further include a plurality of display elements. Each display element can be in electrical communication with one of the plurality of common lines and one of the plurality of segment lines. Further, the display apparatus can include first connection means for electrically connecting the first data line of a first segment line and a first set of display elements along the first segment line. In addition, the display apparatus can include second connection means for electrically connecting the second data line of the first segment line and a second set of display elements along the first segment line. The first connection means can be structurally different from the second connection means. At least some of the structural differences can be positioned such that they do not cause substantial differences in visual appearance between display elements of the same color, or at least some of the structural differences can alternate at a rate such that any differences in visual appearance are not visually resolvable by a viewer.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 is a block diagram illustrating examples of a column driver and a row driver for driving an implementation of an array of display elements.

FIG. 10 is a block diagram illustrating examples of a column driver and a row driver having at least some bifurcated segment lines for driving an implementation of an array of display elements.

FIG. 11 is a block diagram illustrating examples of a column driver and a row driver where the common electrodes are removed to illustrate the segment electrodes.

FIG. 12A is a cross sectional view of a display array showing connections between the electrical lines and the optical stacks of FIG. 11.

FIG. 12B is a top plan view of the display array of FIG. 12A that only illustrates the outlines of data lines and segment electrodes, according to various implementations.

FIG. 13 is a block diagram illustrating examples of a row driver and a column driver configured for multiple data line routing for driving an implementation of an array of display elements.

FIG. 14A is a top plan view of a portion of a display array that is configured for multiple data line routing.

FIGS. 14B and 14C are cross-sectional side views of the implementation of FIG. 14A.

FIGS. 14D and 14E are micrographs of interconnects that electrically couple the data lines to the segment electrodes.

FIG. 14F illustrates an image that is displayed when simultaneously writing common lines that utilize structurally different interconnects to couple the data lines to the segment electrodes.

FIG. 15A is a top plan view of a portion of a display array that alternates structurally different interconnects at a high spatial frequency, according to one implementation.

FIGS. 15B and 15C are cross-sectional side views of the implementation of FIG. 15A.

FIG. 16A is a top plan view of a portion of a display array that alternates structurally different interconnects at a high spatial frequency, according to another implementation.

FIGS. 16B and 16C are cross-sectional side views of the implementation of FIG. 16A.

FIG. 17 is a flowchart illustrating a method of manufacturing a display, according to one implementation.

FIGS. 18A and 18B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

According to some implementations, a driving scheme for an array of display elements includes more segment lines than columns of display elements, and a reduced number of common driver outputs for driving common lines of the display. According to some implementations, rows of different colors having different levels of visual importance include display element segment electrodes having different sizes or areas. In some implementations, each of the rows includes display elements having only one color, and multiple rows having the same color display elements are simultaneously and passively addressed using the same output from a common line driver.

Particular implementations of the subject matter described in this disclosure can be implemented to reduce artifacts in images displayed by an array of display elements. In particular, some of the implementations disclosed herein are useful in artifact reduction in displays that adopt multiple data line routing, wherein each data line can be implemented using an interconnect structure different from the other data line(s). The interconnect structures for each data line can be arranged such that when two or more display elements of a particular color controlled by different data lines (and consequently connected to the segment electrode(s) by different interconnect structures) are simultaneously written, the displayed colors are substantially the same and there are minimal or no image artifacts (e.g., stripes) due to the different interconnect structures.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

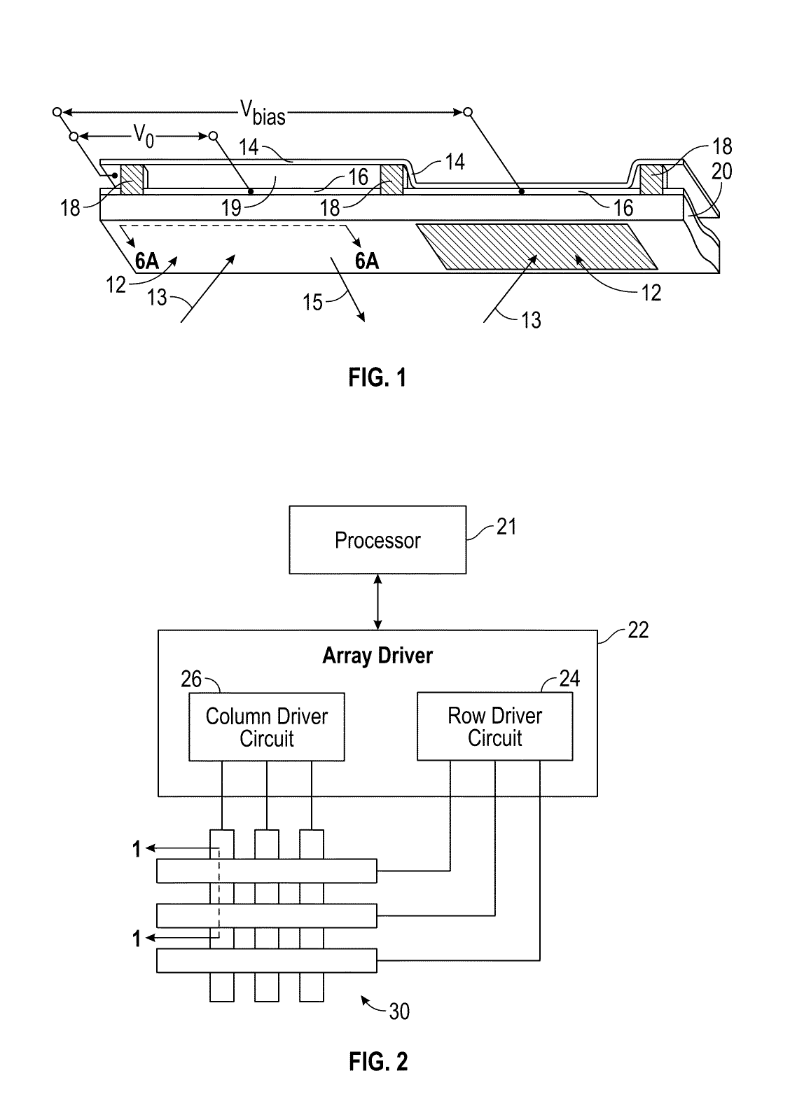

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

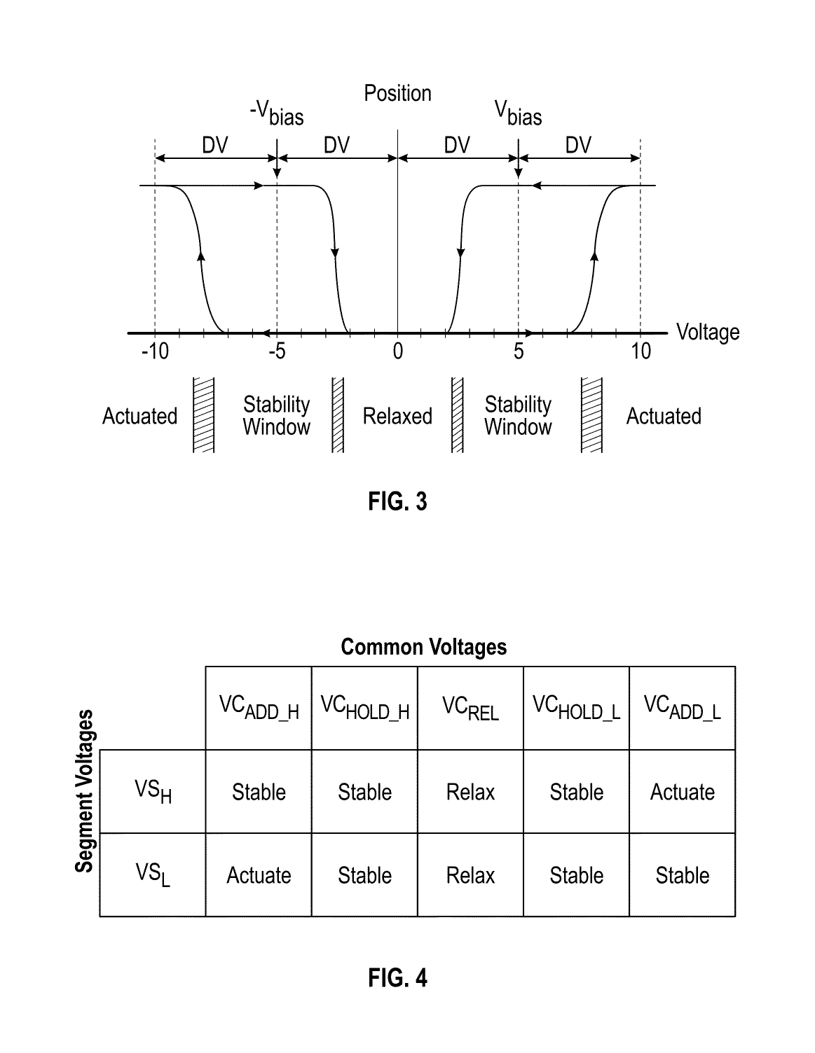

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

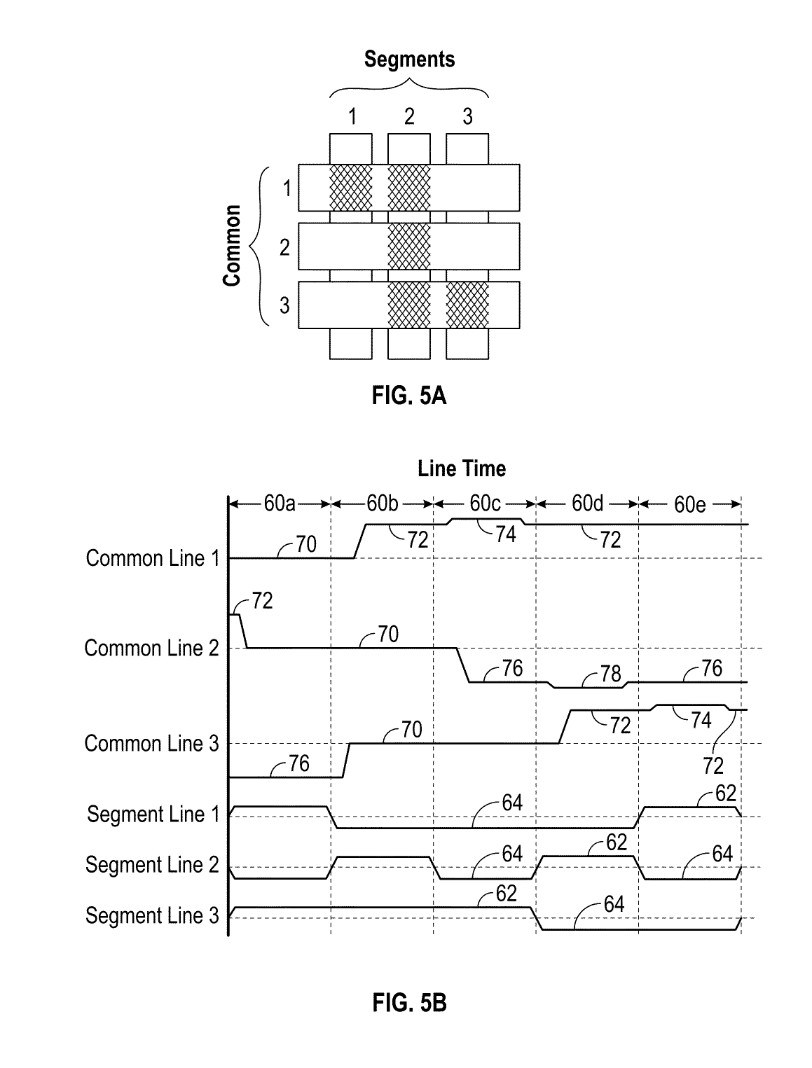

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or minor, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

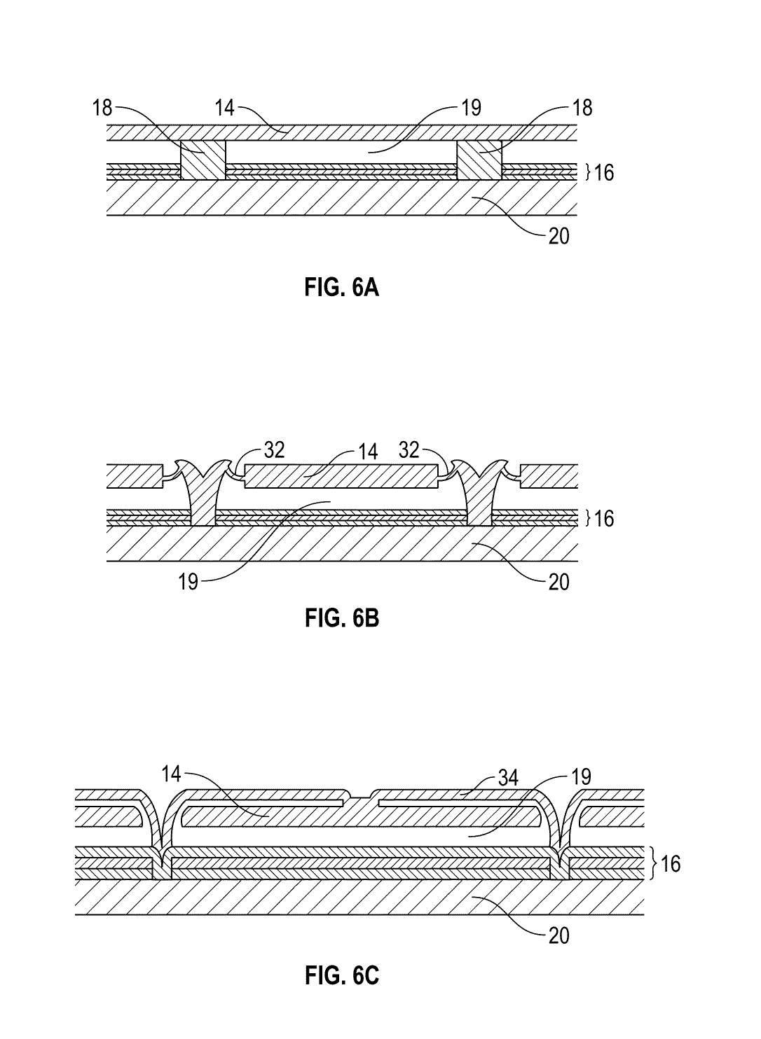

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

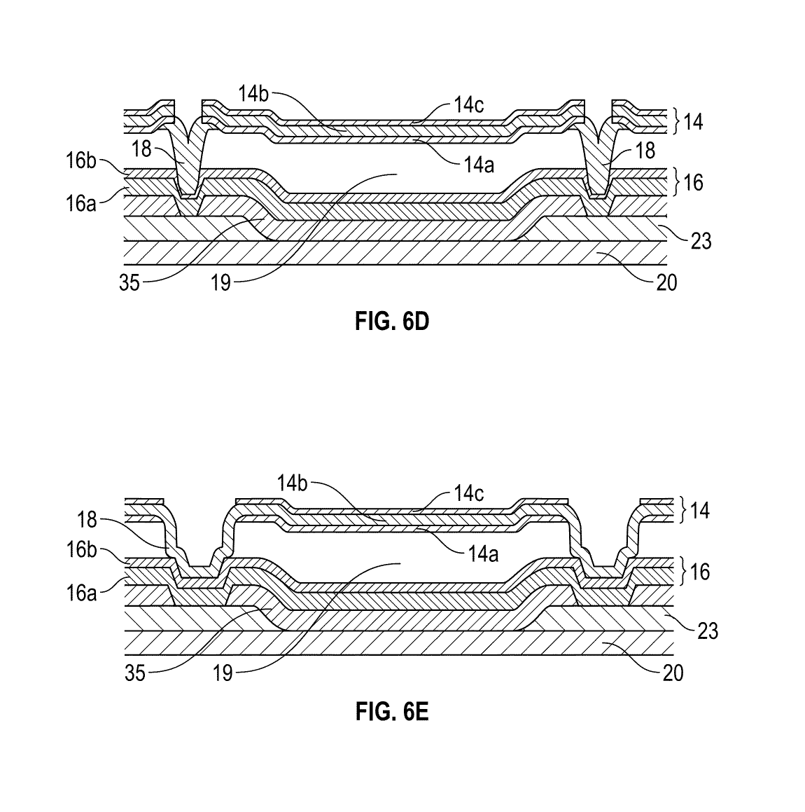

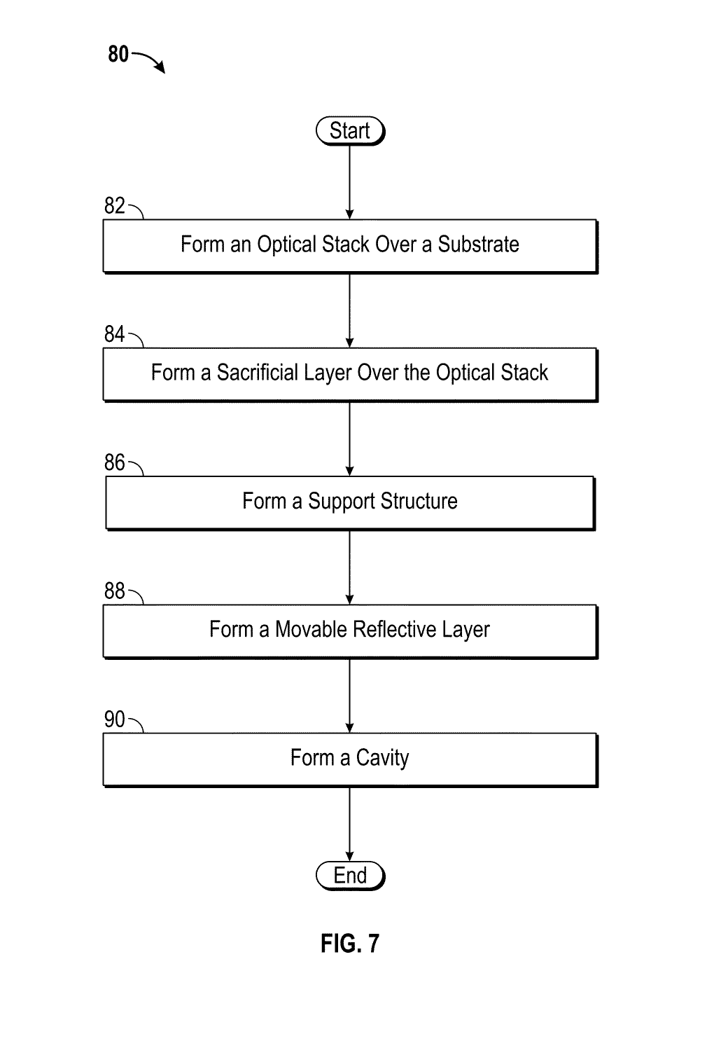

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

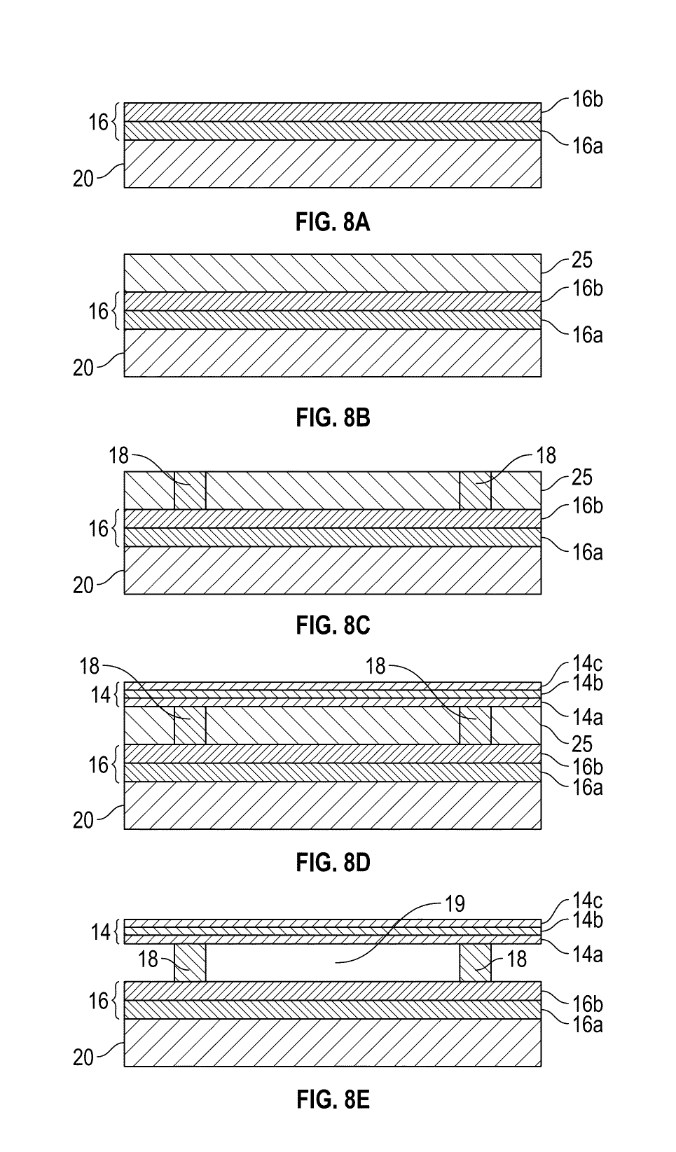

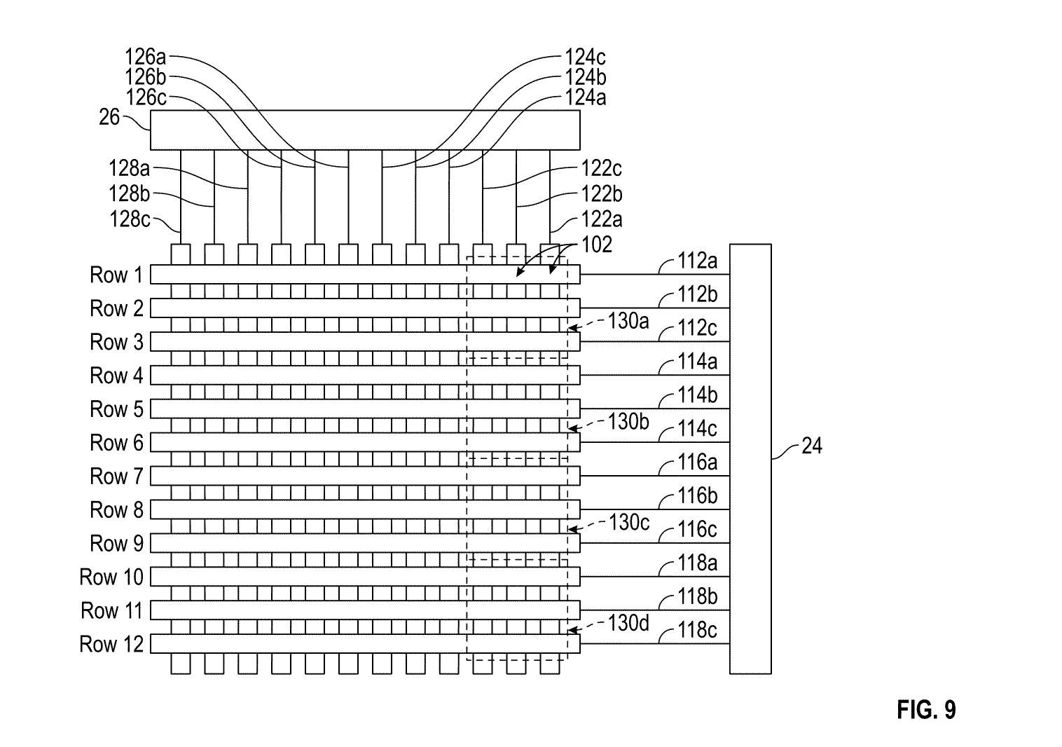

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

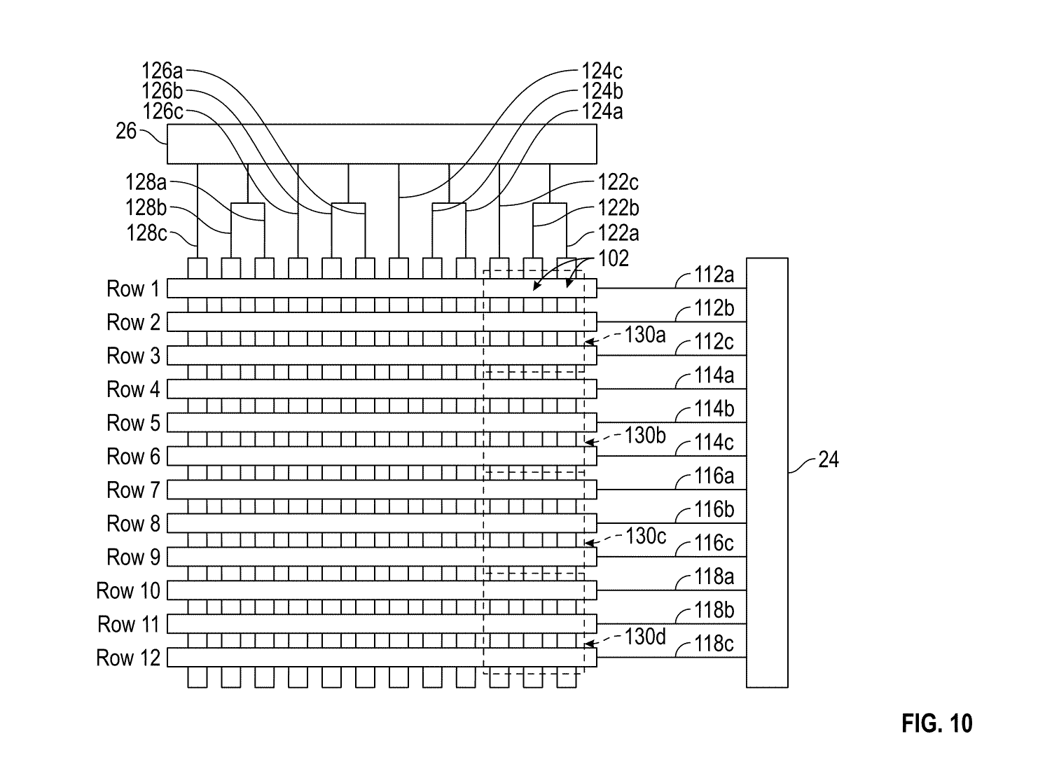

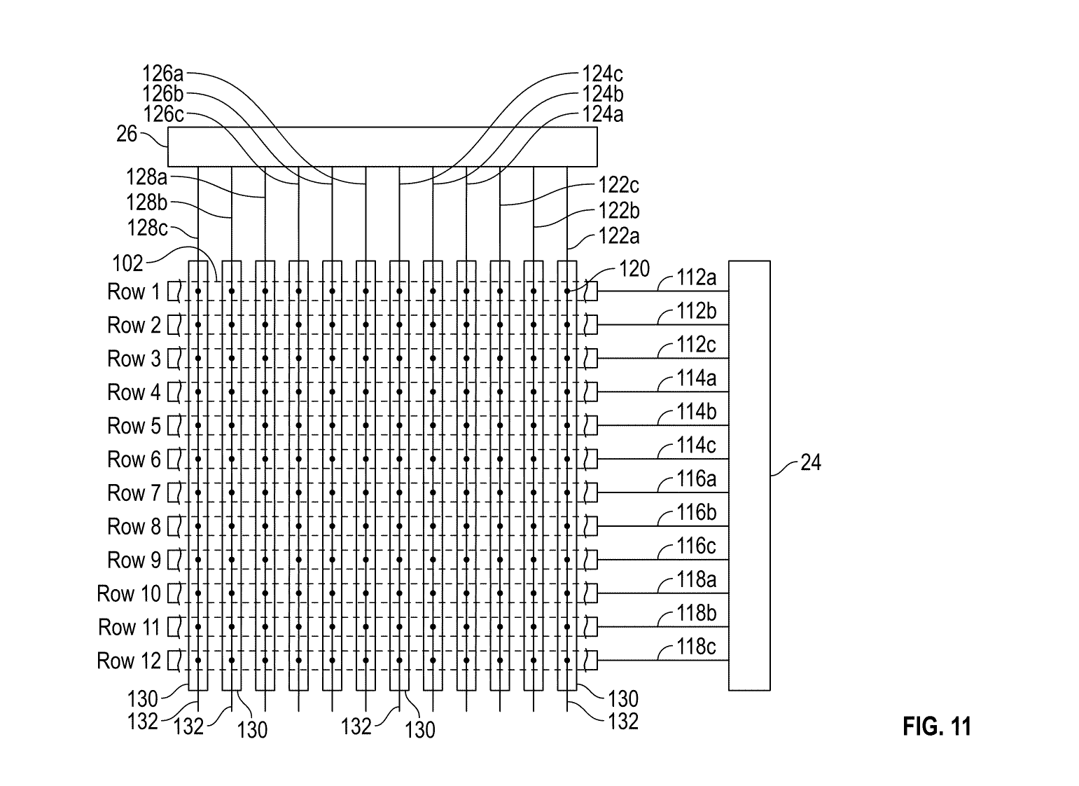

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

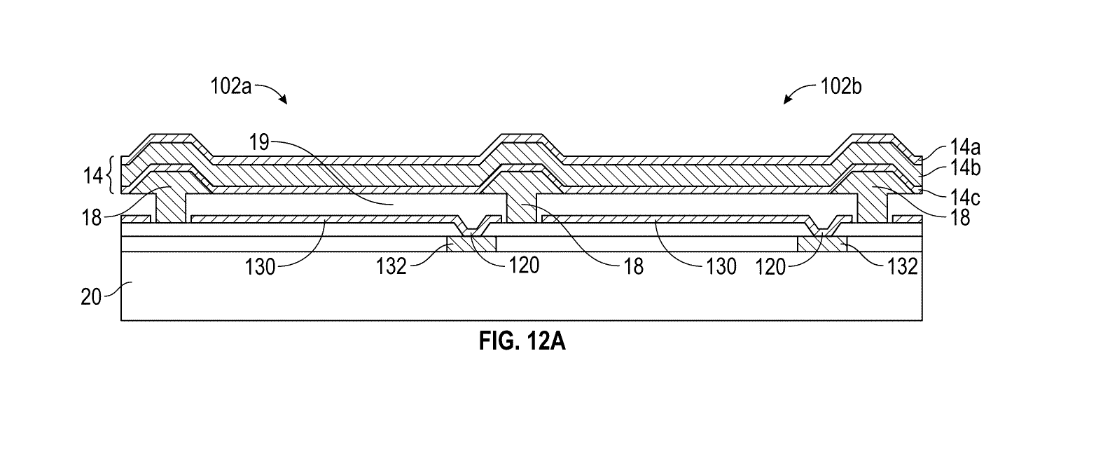

In certain displays, the number of physical display elements, such as, interferometric modulators, is greater than the number of logical display elements. The disparity may arise when multiple display elements are used for a single pixel in order to provide multiple colors per pixel. Multiple display elements per color may be used in each pixel to enable techniques such as spatial dithering. An example of such a set up is shown in FIG. 9 which has pixels 130a-130d each of which are formed by a square array of nine display elements 102.

FIG. 9 is a block diagram illustrating examples of a column driver circuit 26 and a row driver circuit 24 for driving an implementation of an array of display elements 102. The array can include a set of electromechanical display elements 102, which in some implementations may include interferometric modulators. A set of segment lines 122a-122c, 124a-124c, 126a-126c, and 128a-128c may be connected to a set of segment electrodes of the array. A set of common lines 112a-112c, 114a-114c, 116a-116c, and 118a-118c may be connected to a set of common electrodes of the array. The segment lines 122a-122c, 124a-124c, 126a-126c, and 128a-128c and common lines 112a-112c, 114a-114c, 116a-116c, and 118a-118c can be used to address the display elements 102, as each display element 102 will be in electrical communication with a segment electrode and a common electrode. In the following description, the column driver circuit 26 will be described as a segment driver configured to drive a plurality of segment lines, while the row driver circuit 24 will be described as a common driver configured to drive a plurality of common lines. The operation of the column driver circuit 26 and the row driver circuit 24 is not limited thereto. For example, the column driver circuit 26 may be configured as a common driver to drive a plurality of common lines, while the row driver circuit 24 may be configured a segment driver to driver a plurality of segment lines. In the implementation of FIG. 9, the column driver circuit 26 is configured to apply voltage waveforms across each of the segment electrodes of the array of display elements, and the row driver circuit 24 is configured to apply voltage waveforms across each of the common electrodes of the array of display elements.

In one driving scheme, display data is provided to each segment line according to the desired data state for a row of display elements. A write pulse is then applied to a single common line to update the display elements 102 in that row. In the display driving scheme of FIG. 9, if there are M columns of display elements 102, the column driver circuit 26 will have M outputs. Similarly, if the there are N rows of display elements 102, the row driver circuit 24 will have N outputs. In terms of pixels having a 9 (3 by 3) sub-pixel architecture, for an array with M columns of display elements 102 and N rows of display elements 102, there will be M/3 columns of pixels, and N/3 rows of pixels.

Still with reference to FIG. 9, in an implementation in which the display includes a color display or a monochrome grayscale display, the individual display elements 102 may correspond to subpixels of larger pixels. Each of the pixels may include some number of subpixels. In an implementation in which the array includes a color display having a set of interferometric modulators, the various colors may be aligned along common lines (or rows as illustrated in FIG. 9), such that substantially all of the display elements 102 along a given common line include display elements 102 configured to display the same color. Some implementations of color displays include alternating rows of red, green, and blue subpixels. For example, lines 112a, 114a, 116a, and 118a may correspond to rows of red display elements 102, lines 112b, 114b, 116b, and 118b may correspond to rows of green display elements 102, and lines 112c, 114c, 116c, and 118c may correspond to rows of blue display elements 102. In one implementation, each 3×3 array of interferometric modulators 102 forms a pixel such as pixels 130a-130d as illustrated in FIG. 9.

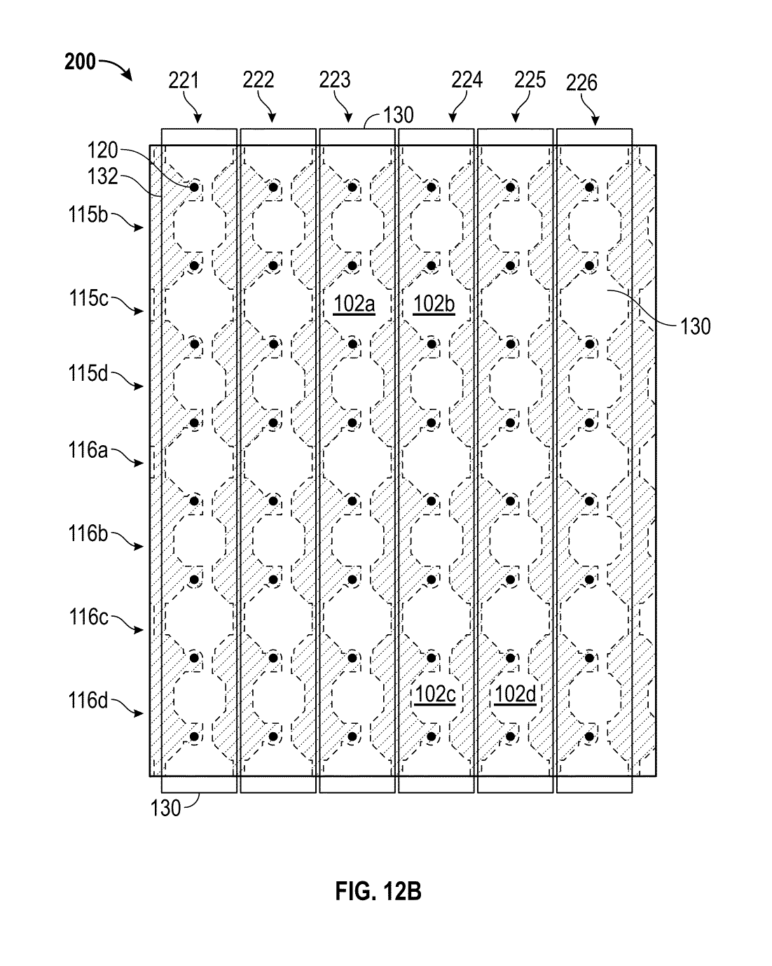

In some implementations, some of the electrodes may be in electrical communication with one another. FIG. 10 is a block diagram illustrating examples of a column driver circuit 26 and a row driver circuit 24 having at least some bifurcated segment lines for driving an implementation of an array of display elements 102. For example, as illustrated in FIG. 10, segment lines 122a and 122b are connected to one-another, such that the same voltage waveform can be simultaneously applied across each of the corresponding segment electrodes connected to segment lines 122a and 122b. In the illustrated implementation of FIG. 10 in which two of the segment electrodes are shorted to one another (e.g., 122a and 122b), a 3×3 pixel will be capable of rendering 64 different colors (e.g., a 6-bit color depth), because each set of three common color display elements 102 in each pixel can be placed in four different states, corresponding to none, one, two, or three actuated display elements 102 (such as interferometric modulators). When using this arrangement in a monochrome grayscale mode, the state of the three pixel sets for each color are made to be identical, in which case each pixel can take on four different gray level intensities. It will be appreciated that this is just one example, and that larger groups of display elements 102 may be used to form pixels having a greater color range with different overall pixel count or resolution.

Because it is coupled to two segment electrodes, the column driver circuit 26 outputs connected to two segment electrodes may be referred to herein as a “most significant bit” (MSB) segment output since the state of this segment output controls the state of two adjacent display elements 102 in each row. Column driver circuit 26 outputs coupled to individual segment electrodes such as at 126c may be referred to herein as “least significant bit” (LSB) segment output since they control the state of a single display element 102 in each row.

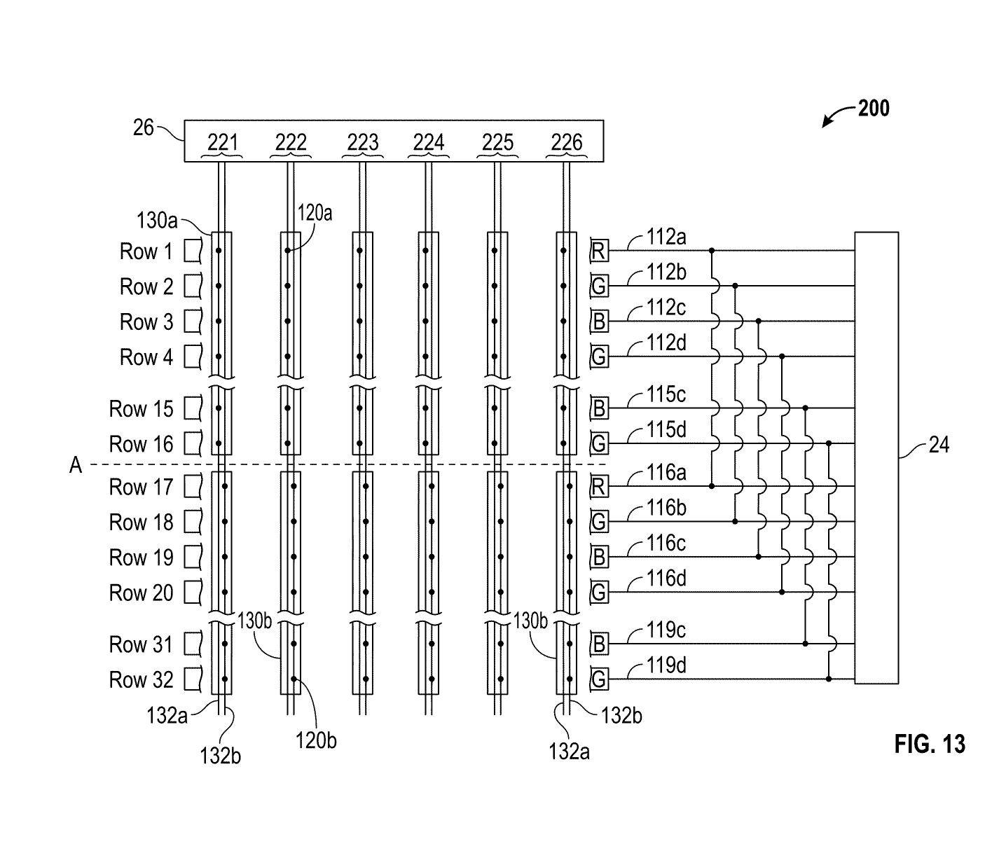

In the array of FIGS. 9 and 10, the row driver circuit 24 has a set of outputs that are connected to common electrodes that extend horizontally in FIGS. 9 and 10 as parallel strips. The column driver circuit 26 has a set of outputs that are connected to segment electrodes that extend vertically in FIGS. 9 and 10 as parallel strips beneath the common electrodes. FIG. 11 is a block diagram illustrating examples of a column driver circuit 26 and a row driver circuit 24 where the common electrodes are removed to illustrate the segment electrodes 130. As illustrated in FIG. 11, the center portions of the common electrodes have been removed to make the segment electrodes 130 visible.

According to some implementations, when the display elements 102 are formed as interferometric modulators, the segment electrodes 130 are deposited layers of a conductive metal (such as chromium) on a substrate (such as glass). The common electrodes may be formed as strips of conductive metal (such as aluminum) suspended on posts over the deposited segment electrode strips. In some implementations, while not illustrated, the segment electrodes may be formed as strips suspended on the posts over deposited common electrode strips. As discussed above, display elements 102 are defined by the regions of adjacent segment electrode and common electrode at the intersection points of the strips. The row driver circuit 24 and column driver circuit 26 apply voltages to the strips with a timing and magnitude to passively address the display elements 102 by selectively actuating and releasing the display elements 102 to display an image. As described herein, passive addressing refers to directly coupling a driving signal from an output of a driver to a display element, without intermediate isolation using switches (such as transistors) or other devices.

While the segment lines in FIGS. 9 and 10 are shown to be connected to the ends of the segment electrodes, the thin conductive metal layer (such as chromium) of the segment electrodes may not be as conductive as desired for driving the display. The configuration in FIG. 11 illustrates an arrangement where the segment electrodes 130 are connected to the column driver circuit 26 by highly conductive data lines (such as data lines 132) that run underneath the segment electrodes. The segment electrodes are connected through vias 120 to the data lines 132 at each point corresponding to a display element 102 as illustrated by the black circles in FIG. 11. Thus, in FIG. 11, each segment line can include a data line 132 that electrically connects to the segment electrode 130.

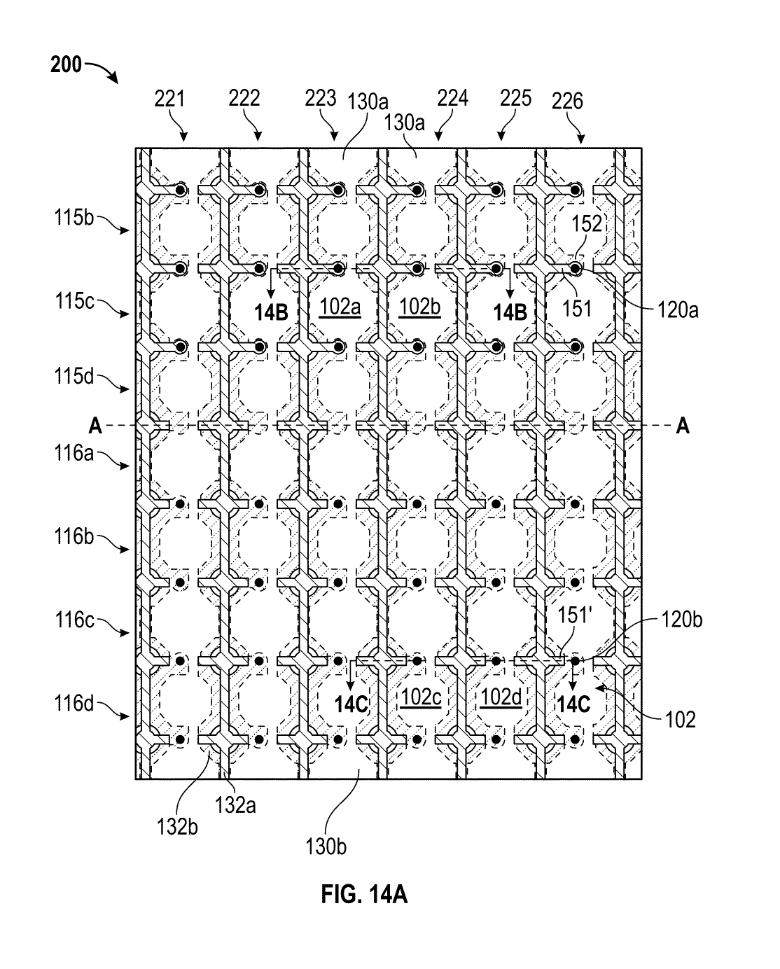

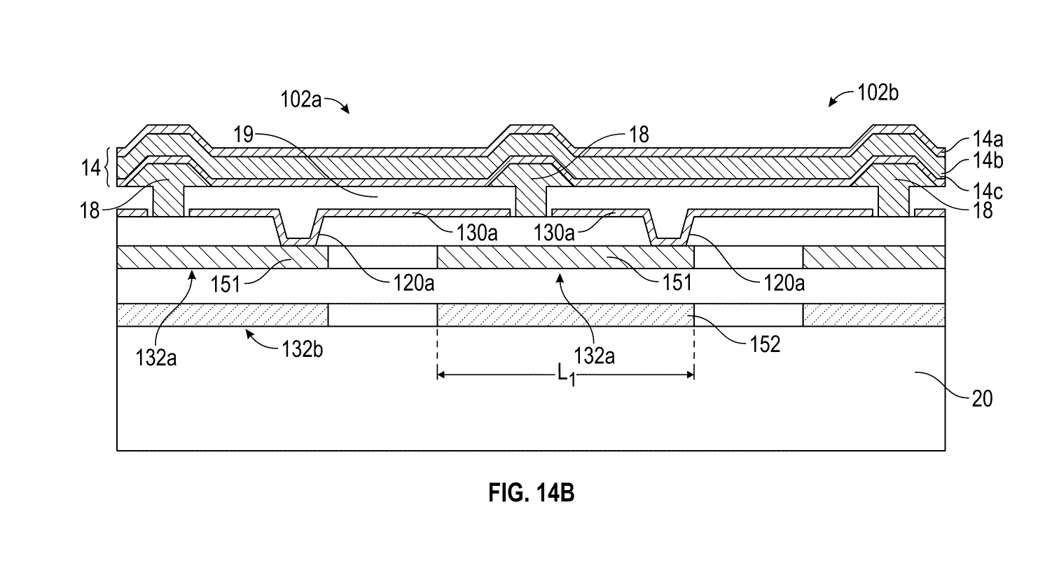

FIG. 12A is a cross sectional view of a display array, showing connections between the data lines 132 and the segment electrodes 130 of FIG. 11. FIG. 12B is a top plan view of the display array of FIG. 12A that only illustrates the outlines of the data lines 132 and the segment electrodes 130, according to various implementations. In particular, FIG. 12A illustrates a cross-section of two adjacent display elements 102a and 102b of the array of display elements illustrated in FIG. 11 which are separated by posts 18. In the array of FIG. 11, the strip segment electrodes are illustrated as strips of conductive material that run vertically down the page. In the cross-section of FIG. 12A, the strip segment electrodes 130 may be formed as part of the optical stack 16 deposited on the substrate 20. As best shown in FIG. 12B, the segment electrodes 130 can take any suitable outline, as seen from a top plan view. Beneath and between the segment electrodes 130 are the data lines 132. The strips of conductive material forming common electrodes running perpendicular to and above the segment electrodes 130 and left to right in the page as illustrated in FIG. 11 correspond to the conductive layers 14c of the display elements 102a and 102b. As illustrated in FIG. 12A, the segment electrodes 130 are connected to the data lines 132 through the vias 120. Because the data lines 132 can be made thicker and of a higher conductivity material than the segment electrodes, an RC time constant of the load on the segment driver (e.g., column driver circuit 26 of FIG. 11) can be reduced. As a result, an optical stack 16 including the segment electrode 130 may respond faster to voltage changes applied by the column driver circuit 26 through the data lines 132.

Because the segment electrodes 130 illustrated in FIG. 12A are continuous strips which traverse along a direction of the array of display elements 102, data may be written to each row of the display separately by providing a write signal from the row driver circuit 24 to the particular row for writing data corresponding to the column driver circuit 26 outputs along that row. As a result, one independent row driver circuit 24 output is provided for each row of display elements. In the configuration of FIGS. 9-11, if multiple rows are connected to the same row driver circuit 24 output, the multiple rows would be written with the same data.

As described above, to write data to the display, the column driver circuit 26 may apply voltages to the segment electrodes or buses along a row of display elements 102 connected to a common line. Thereafter, the row driver circuit 24 may pulse a selected common line connected thereto to cause the display elements 102 along the selected line to display the data, for example by actuating selected display elements 102 along the line in accordance with the voltages applied to the respective segment outputs. After display data is written to the selected line, the column driver circuit 26 may apply another set of voltages to the buses connected thereto, and the row driver circuit 24 may pulse another line connected thereto to write display data to the other line. By repeating this process, display data may be sequentially written to any number of lines in the display array. The time required to write a frame of data for the display therefore corresponds to the time required to write one row times the number of rows.

Therefore, the time of writing display data (a.k.a. the frame write time) to the display array using the above described driving scheme is generally proportional to the number of lines of display data being written. In many applications, it is advantageous to reduce the frame write time, for example, to increase the frame rate of a display or to smooth the appearance of moving video images, for example. For example, in some implementations, two or more common lines can be written simultaneously by applying a write waveform to the two or more common lines at substantially the same time. For example, in some implementations of the display shown in FIG. 11, two red common lines 112a and 114a can be written simultaneously, two green common lines 112b and 114b can be written simultaneously, and two blue common lines 112c and 114c can be written simultaneously. By writing two common lines of each color simultaneously, the frame write time can be halved, because the common line driver only addresses half as many common lines. It should be appreciated that more than two common lines can be written simultaneously in other implementations.

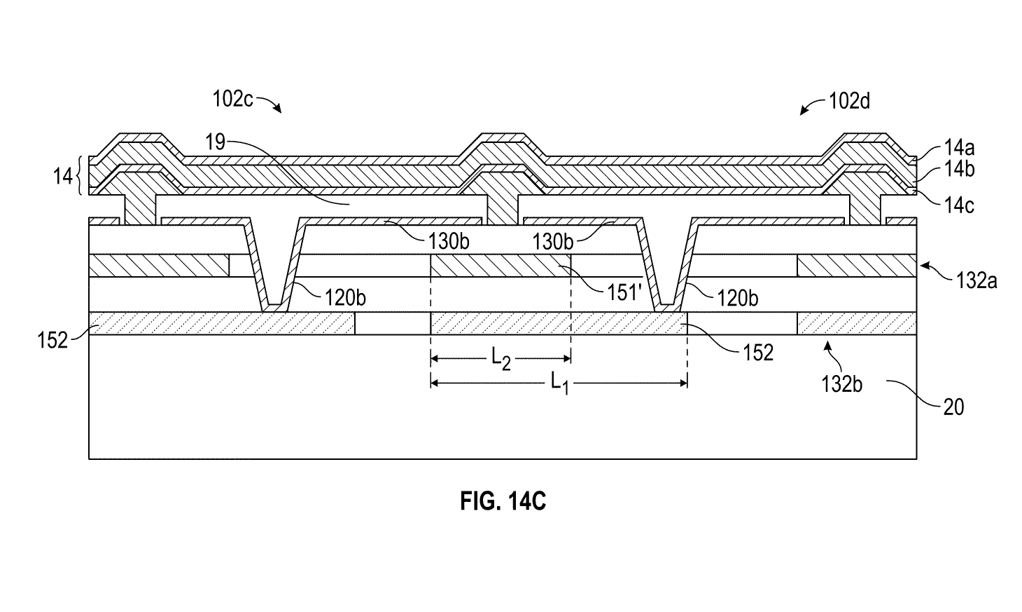

In some implementations, it can be advantageous to transmit multiple data signals along a single segment line, also referred to herein as multiple data line routing, so that the two lines written simultaneously can be written with different data. FIG. 13 illustrates one implementation of a portion of a display array 200 configured for multiple data line routing. A column driver circuit 26 and a row driver circuit 24 are schematically illustrated in FIG. 13, and, as in FIG. 11, the center portions of the common electrodes have been removed to make the segment electrodes 130 visible. The display array of FIG. 13 includes two sets of common lines, a first set of common lines spanning Rows 1-16 and a second set of common lines spanning Rows 17-32. Although each set of common lines in FIG. 13 includes 16 common lines, it should be appreciated that any suitable number of common lines can be included in a set of common lines. For example, in other implementations, each set can include between 2 and 32 common lines; any other suitable number of common lines can be included in a set. For instance, in some implementations, each set can include 4 common lines.

In FIG. 13, six segment lines 221, 222, 223, 224, 225, and 226 are illustrated. Skilled artisans will appreciate that the number of segment lines shown is only for illustrative purposes; any suitable number of segment lines can be used in a display. Each segment line can include multiple data lines 132 and multiple segment electrodes 130. For example, FIG. 13 illustrates a portion of a display with each segment line including a first data line 132a and a second data line 132b, and a first segment electrode 130a and a second segment electrode 130b. As in the implementation of FIG. 12A, the data lines 132 can electrically connect to the segment electrodes by way of vias 120. For example, the first data line 132a can electrically couple to the first segment electrode 130a through a first via 120a. Similarly, the second data line 132b can electrically couple to the second segment electrode 130b through a second via 120b.

The data lines 132a, 132b can be arranged to transmit independent data signals to the electrodes 130a, 130b though the first and second vias 120a, 120b, respectively. Because the first segment electrode 130a is electrically separated from the second segment electrode 130b at line A, the first data line 132a can transmit a first set of data signals to the display elements written by the first set of common lines in Rows 1-16. Similarly, the second data line 132b can transmit a second set of data signals to the display elements written by the second set of common lines in Rows 17-32. The first and second data lines 132a, 132b can thereby transmit independent data signals to the top and bottom halves of the portion of the display array 200 illustrated in FIG. 13. It should be appreciated that the portion of the display array 200 shown in FIG. 13 can be repeated along the display such that each subsequent set of sixteen common lines writes data transmitted by a data line different from the previous set of sixteen common lines.

Multiple data line routing can be advantageous when implementing display modes that simultaneously write two or more common lines. As explained above, writing multiple common lines simultaneously can beneficially increase the update rate of a display. For example, in FIG. 13, one common line from the first set of common lines (e.g., Rows 1-16) can be written simultaneously with one corresponding common line from the second set of common lines (e.g., Rows 17-32). Thus, in some implementations, red common line 112a of the first set can be written at substantially the same time as red common line 116a of the second set. Green common line 112b of the first set can be written at substantially the same time as green common line 116b of the second set. Blue common line 112c of the first set can be written at substantially the same time as blue common line 116c of the second set. Green common line 112d of the first set can be written at substantially the same time as green common line 116d of the second set. Similarly, the other corresponding common lines in the first and second sets can be written simultaneously.

Although the term “simultaneously” is used throughout the discussion of FIG. 13 and other portions of the present disclosure for the purposes of conciseness, the voltage waveforms need not be perfectly synchronized. As discussed above with respect to FIG. 5B, the write waveform may include an overdrive or address voltage during which the potential difference across a display element is sufficient to result in data being written to that display element given an appropriate segment voltage. So long as there is sufficient overlap between the overdrive or address voltages of the write waveforms applied across the common lines and the data signals applied across the segment lines that actuation of the display elements on any of the addressed common lines can occur, the write waveforms and data signals are considered to be applied, or written, simultaneously.

Because each segment line 221-226 in FIG. 13 includes two data lines 132a, 132b, independent image data can be written during a simultaneous write process of two or more common lines. For example, if red common lines 112a and 116a are written simultaneously, then the red common line 112a can be written with data transmitted along the first data lines 132a, and the red common line 116a can be written with the data transmitted along the second data lines 132b. Similarly, if the green common lines 112b and 116b are written simultaneously, then the green common line 112b can be written with data transmitted along the first data lines 132a, and the green common line 116b can be written with the data transmitted along the second data lines 132b. If the blue common lines 112c and 116c are written simultaneously, then the blue common line 112c can be written with data transmitted along the first data lines 132a, and the blue common line 116c can be written with the data transmitted along the second data lines 132b. The remainder of the display array can be written in a similar manner.

By contrast, in the implementation of FIG. 11, there is only one data line 132 per segment line. Simultaneously writing the two red common lines 112a and 114a shown in FIG. 11 would result in the same image data being written to the display elements along both common lines 112a and 114a. The implementation of FIG. 13 allows two common lines to display independent data even when they are written simultaneously.

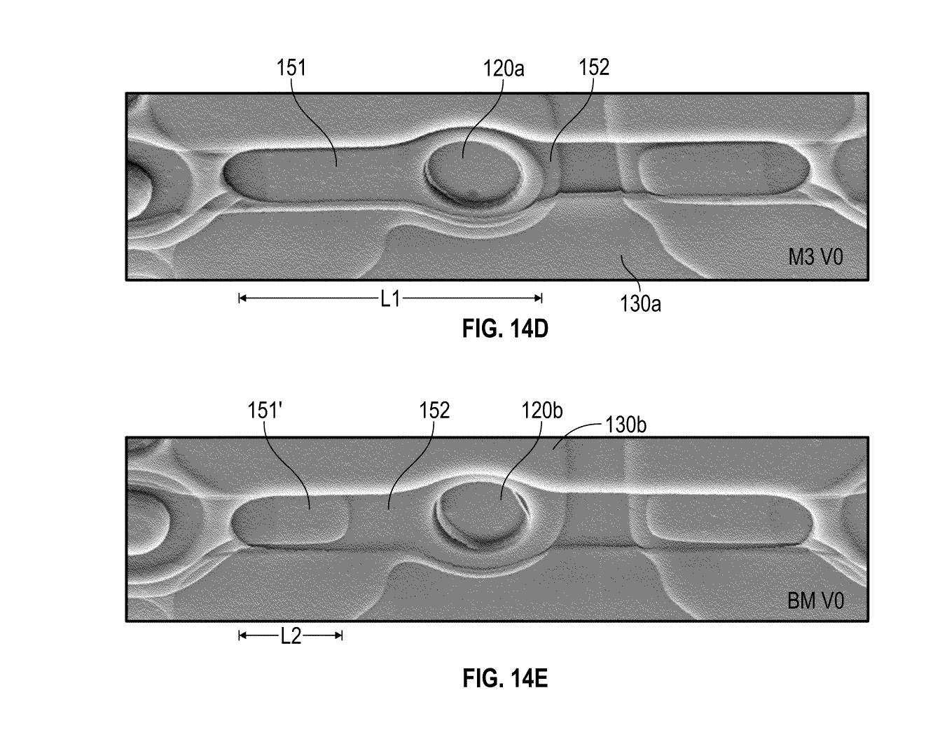

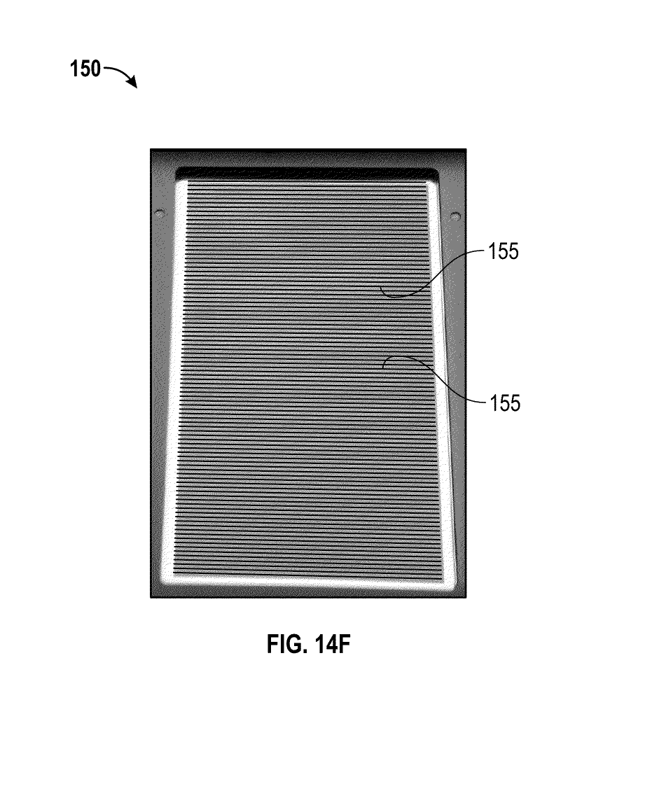

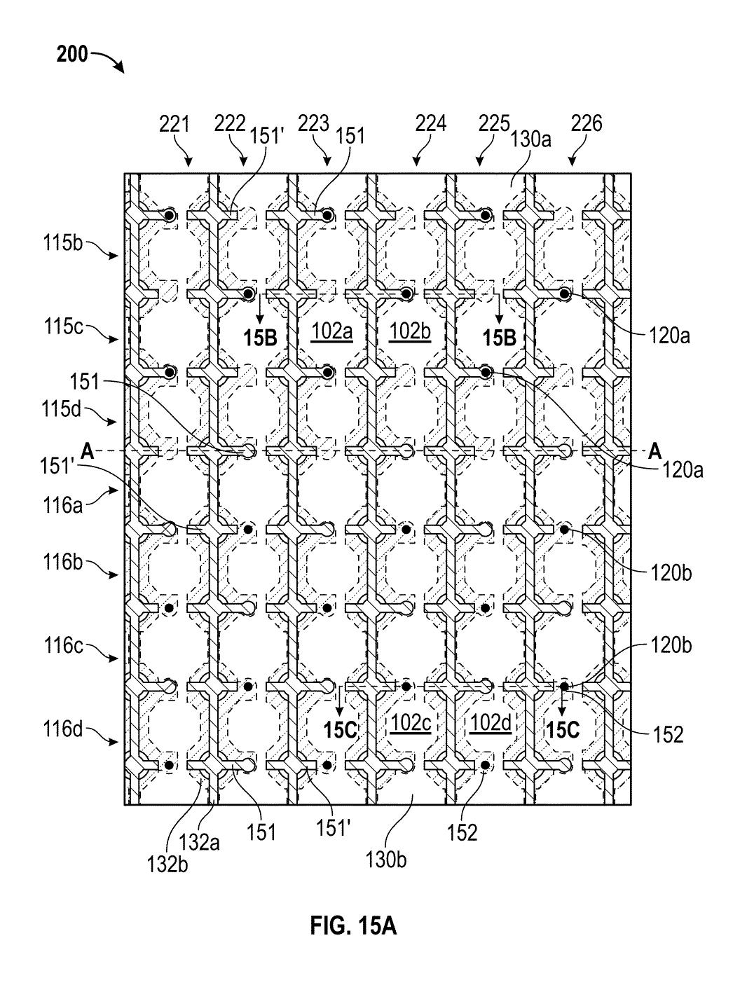

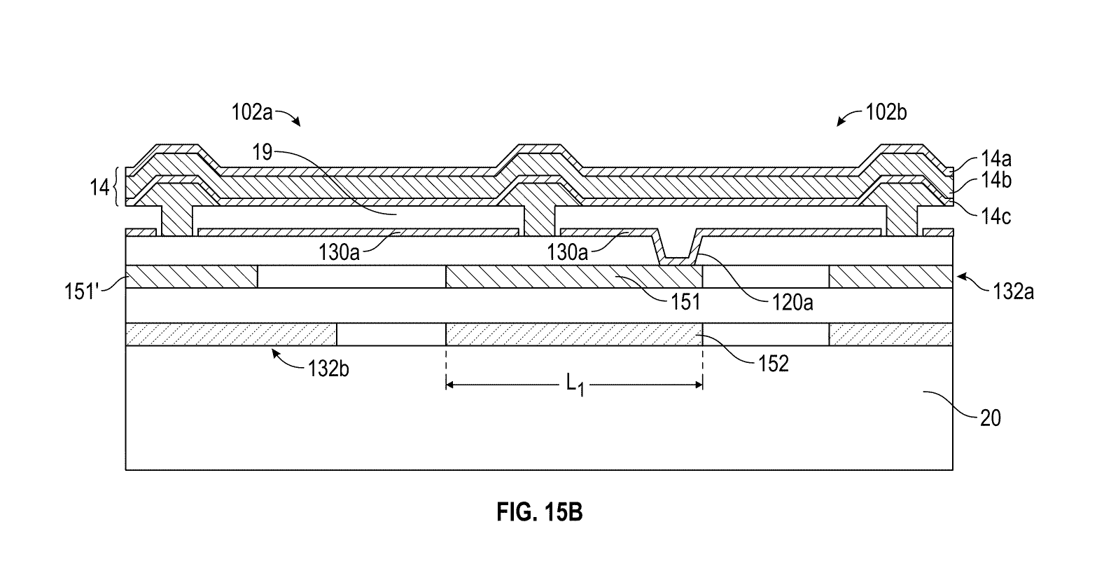

Turning to FIG. 14A, a portion of a display array's structural features are illustrated in a top plan view. FIGS. 14B and 14C illustrate side cross-sectional views along the respective cross-sections illustrated in FIG. 14A. Unless otherwise noted herein, reference numerals similar to those of FIG. 13 are used to denote similar components in FIGS. 14A-E. Note that, for purposes of illustration, the layer(s) of the display including the common lines, e.g., the movable reflective layer 14, are not shown in FIG. 14A. The layer(s) defining the common lines can generally be formed above and horizontally across the structures illustrated in FIG. 14A. Indeed, in FIGS. 14B and 14C, the data lines 132a, 132b and the segment electrodes 130a, 130b extend out of the page from the reader's perspective. Further, as shown in FIGS. 14B and 14C, the movable reflective layer 14 (e.g., which can be configured as a common line) can be formed over the posts 18 and can extend transverse or substantially perpendicular to the data lines 132a, 132b and the segment electrodes 130a, 130b. As explained above, a particular display element can be actuated by applying a voltage across the common line and segment line that define the particular display element 102.

As in FIG. 13, each segment line 221-226 of the displayed portion 200 of the display can include at least a first electrode 130a and a second electrode 130b. The first electrode 130a and the second electrode 130b can be electrically separated at line A. Further, each segment line 221-226 can include a first data line 132a and a second data line 132b, each configured to transmit independent data signals. In some implementations, the first data line 132a can be formed from a first layer, and the second data line 132b can be formed from a second layer. As best seen in FIGS. 14B and 14C, the first data line 132a can be formed in a layer disposed between the layer for the second data line 132b and the layer for the segment electrodes 130a, 130b. An insulating layer 20, which can be optically transparent in some implementations, may be disposed between the segment electrodes 130a, 130b and the first data lines 132a, and between the first data lines 132a and the second data lines 132b.

In FIG. 14B, a first electrical interconnect formed by via 120a can electrically couple the first segment electrode 130a and the first data line 132a. For example, the first electrical interconnect of FIG. 14B can include the first conductive via 120a and a first arm 151 of the first data line 132a. As shown, the first data line 132a can include the first arm 151 that has a first length L₁. The first arm 151 of the first data line 132a can extend along a perimeter of the display elements 102a, 102b, as shown in FIGS. 14A and 14B. The first via 120a can couple to a distal end portion of the first arm 151 as illustrated in the implementation of FIG. 14B. In addition, a second arm 152 of the second data line 132b can extend underneath the first data line 132a and along the perimeter of the display elements 102a, 102b. The second arm 152 can be any suitable length. As shown in FIG. 14B, for example, the second arm 152 can be about the same length L₁ as the first arm 151 in various implementations. However, in other implementations, the second arm 152 can be longer or shorter than the first arm 151. In the illustrated cross-section of FIG. 14B and along the illustrated common line, the second arm 152 is not in electrical communication with the first segment electrode 130a, allowing for separate data signals to be applied by way of the first arm 151 of the first data line 132a.

As illustrated in FIG. 14B, the first segment electrode 130a electrically couples to the first data line 132a, but not to the second data line 132b. Thus, because the first segment electrode 130a does not electrically communicate with the second data line 132b in the cross-section shown in FIG. 14B, a first data signal transmitted through the first data line 132a can be independent and/or different from a second data signal transmitted through the second data line 132b.

In FIG. 14C, a second electrical interconnect is illustrated that electrically couples the second segment electrode 130b and the second data line 132b for display elements 102c and 102d. For example, the second electrical interconnect of FIG. 14C can include the second conductive via 120b and the arm 152 of the second data line 132b. To couple the second segment electrode 130b to the arm 152, the arm 151′ of data line 132a can be formed to have a length L₂ that is shorter than the first length L₁. As shown, the conductive via 120b can be formed beyond a distal end of the arm 151′ to electrically couple a distal end portion of the arm 152 to the second electrode 130b. The second conductive via 120b can thereby maintain electrical separation from the first data line 132a while electrically communicating with the second data line 132b formed underneath the first data line 132a. Electrical communication between the arm 152 of the data line 132b can thus provide a second data signal separate from the first data signal transmitted along the first data line 132a.

As an example, FIGS. 14D and 14E are micrographs of first and second interconnects according to some implementations. As shown in FIG. 14D, the first segment electrode 130a can electrically communicate with the arm 151 by way of the via 120a coupled to a distal end portion of the arm 151. In FIG. 14E, the arm 152 can electrically communicate with the second segment electrode 130b by way of the via 120b. As shown, the arm 151′ of FIG. 14E has a length L₂ that is shorter than the length L₁ of the arm 151 of FIG. 14D. The via 120b can therefore pass by or be formed beyond a distal end of the first arm 151′.

The first interconnect coupling the first segment electrodes 130a to the first data lines 132a may be structurally different from the second interconnect coupling the second segment electrodes 130b to the second data lines 132b. For example, the first arm 151 of FIG. 14D of the first interconnect can have a length L₁ that is longer than the length L₂ of the first arm 151′ of the second interconnect. Moreover, the first via 120a of the first interconnect can be formed to extend downward from the first segment electrode 130a through a layer of insulating material to couple to the distal end portion of the first arm 151. By contrast, the second via 120b of the second interconnect can extend from the second segment electrode 130b through the insulating layer past or beyond the distal end of the first arm 151′.

Because there are structural differences in the first and second electrical interconnects of FIGS. 14A-C, there may be differences in the electrical and/or optical properties for display elements coupled to the first interconnect and for display elements coupled to the second interconnect. For example, consider two display elements configured to display the same color. The first display element may be coupled to the first interconnect, and the second display element may be coupled to the second interconnect. A hold voltage applied to the first interconnect may cause the movable reflective layer 14 to deflect slightly such that the air gap 19 separating the reflective layer 14 from the segment electrode 130 is a first height. The same voltage applied to the second interconnect may cause the movable reflective layer 14 to deflect by a different amount due to the structural differences between the interconnects such that the air gap 19 during application of hold voltages is greater than or less than the air gap 19 of the first display element. As explained above, the color reflected by the display elements 102 can be related to the height of the air gap 19 between the reflective layer 14 and the segment electrodes 130. Thus, if two display elements are otherwise the same except that they are connected to two structurally different interconnects, then the two display elements may display a slightly different color when rendering an image.

In sum, when two display elements configured to display the same color are connected to two structurally different interconnects, applying the same voltage to the two display elements may cause the two display elements to display slightly different colors.

FIG. 14F illustrates an example of an image artifact that can arise due to the structural differences between the first and second interconnects. FIG. 14F illustrates an image 150 displayed on a display array similar to that illustrated in FIGS. 13 and 14A-C. In particular, the displayed image 150 illustrates image data written by simultaneously writing two common lines of each color that are separated by 15 common lines. In other words, the first common line and the sixteenth common line (e.g. red) are simultaneously written, then the second common line and the seventeenth common line (e.g., green) are simultaneously written, and so on, as explained with respect to FIG. 13. As shown in the image, the displayed image 150 can display multiple stripes 155 that occur every sixteen common lines, corresponding to the different interconnects that couple to the display elements every sixteen common lines. As evident by the stripes 155 of FIG. 14F, it can be advantageous to remove these image artifacts from the displayed image 150 to improve image quality, while still maintaining the advantages associated with multiple data line routing (e.g., higher frame rates).

In one implementation, the striped pattern 155 of FIG. 14F can be reduced or eliminated by ensuring that the structural differences do not cause substantial differences in visual appearance between display elements of the same color, or that the structural differences alternate at a rate such that any differences in visual appearance are not visually resolvable by a viewer. One way to accomplish this goal is to alternate the structural differences on a display element by display element basis in each dimension. For example, the display array 200 may be configured to alternate structurally different interconnects at a high spatial frequency. If the structural differences are interspersed at high frequency throughout the display array 200, then the human eye is not able to resolve the visual differences induced by the structural differences of the two interconnects. Moreover, alternating the structurally different interconnects produces a more uniform arrangement of structures around each display element, which can reduce or eliminate the color differences caused by the arrangement of structural differences illustrated in FIG. 14A.

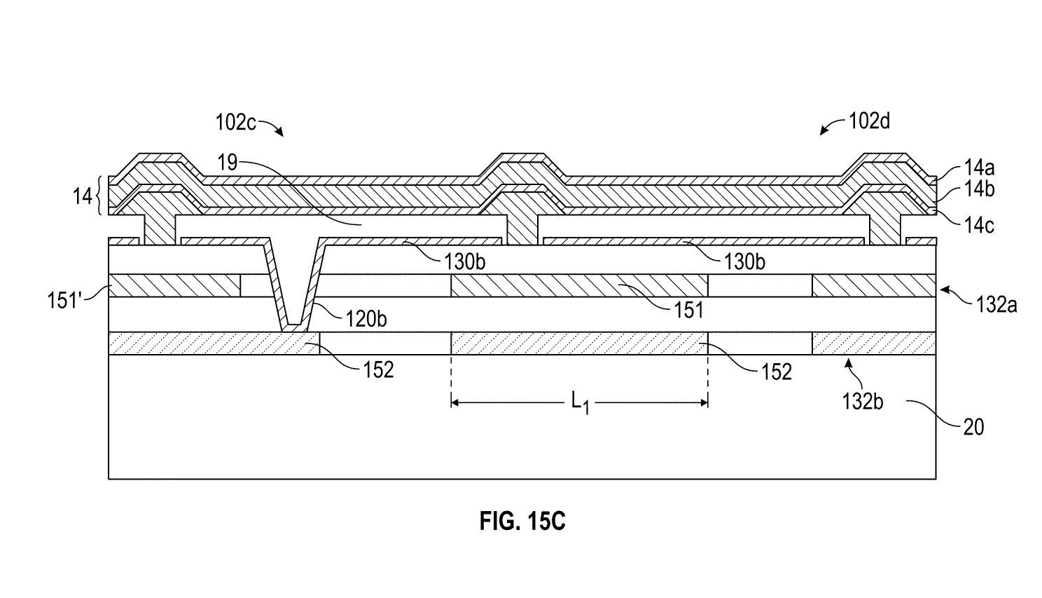

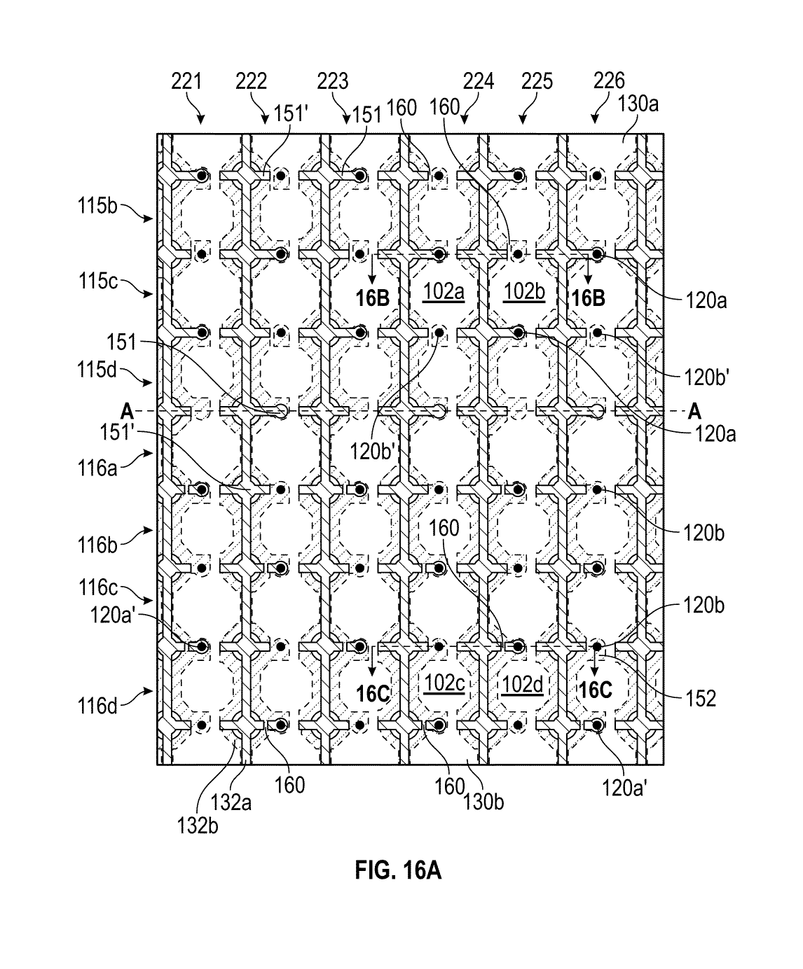

For example, FIGS. 15A-C illustrate one implementation that alternates the interconnect structure along adjacent segment lines and common lines. As in FIGS. 13 and 14A-C, the display elements 102a and 102b in the upper portion of the display array 200 may electrically couple to the first data line 132a by way of the first interconnect, and the display elements 102c and 102d in the lower portion of the array 200 may electrically couple to the second data line 132b by way of the second interconnect. For example, the first via 120a provides electrical communication between the first electrode 130a and the first data line 132a, and the second via 120b provides electrical communication between the second electrode 130b and the second data line 132b.

However, unlike in FIG. 14A, only the bottom perimeter of the display element 102a in FIGS. 15A-B includes the arm 151a extending to via 120a, and only the top perimeter of the adjacent display element 102b includes the arm 151 extending to via 120a. In contrast, in FIGS. 14A-C, arms 151 extending to vias 120a are formed along both the top and bottom perimeters of the display elements 102a, 102b such that electrical connections are made at both the top and bottom perimeters of the display elements 102a, 102bs.

As shown in FIGS. 15A-B, the upper perimeter of element 102a includes the shorter arm 151′ having the second length L₂ that is shorter than the first length L₁ of the first arm 151 of the first interconnect. Thus, while the via 120a along the bottom perimeter of the display element 102a provides electrical communication to the first data line 132a, providing the shorter arm 151′ along the top perimeter of the display element 102a alternates structural differences at a high spatial frequency. Similarly, the via 120a at the top perimeter of the display element 102b provides electrical communication to the first data line 132a. However, a shorter arm 151′ is provided along the bottom perimeter of the display element 102b to alternate structural differences at a high spatial frequency.

As shown in FIGS. 15A-15B, each display element 102a, 102b in the top half of the display can include arm structures of both long and short length, while still maintaining electrical communication with only the first data line 132a. In other words, each of the two display elements 102a, 102b can incorporate the structural features of both arm types. For example, each display element 102a, 102b includes first arms 151, 151′ having the two different lengths L₁ and L₂.

Turning to FIGS. 15A and 15C, the display elements 102c and 102d may similarly include both longer arms 151 and shorter arms 151′ on their perimeter. As in FIGS. 14A-C, the vias 120b still provides electrical communication between the second data line 132b and the second segment electrode 130b. Indeed, as shown, a via 120b can be formed along the top perimeter of the display element 102c and along the bottom perimeter of the display element 102d next to the end of a shorter arm 151′. A longer arm 151 can be formed along the bottom perimeter of the display element 102c and along the top perimeter of the display element 102d. These longer arms do not electrically communicate with any data lines because they do not include a via 120a. Rather, the longer arms introduce the structural differences at a high spatial frequency.

Because both structures are included around each single display element 102a, 102b, 102c, and 102d, any differences in visual appearance between display elements of the same color may be reduced or eliminated. Moreover, even if visual differences remain, the differences may alternate at a high enough frequency such that the visual differences would not be perceived by the human eye. By contrast, in FIGS. 14A-C, the structural differences between the first and second interconnects alternate at a relatively low spatial frequency, e.g., every 16 common lines, such that differences in visual appearance between display elements of the same color may be perceived by the viewer.

In sum, the implementations of FIGS. 15A-C address the image artifacts shown in FIG. 14F by alternating the structural differences between the two interconnects. While the structural differences in the two interconnects are alternated every 16 common lines in FIGS. 14A-14E, the structural differences are alternated within each display element 102 and/or across adjacent common lines and segment lines in FIGS. 15A-C. By including structures similar to both interconnects within each display element and/or adjacent common or segment line, visual artifacts are reduced.

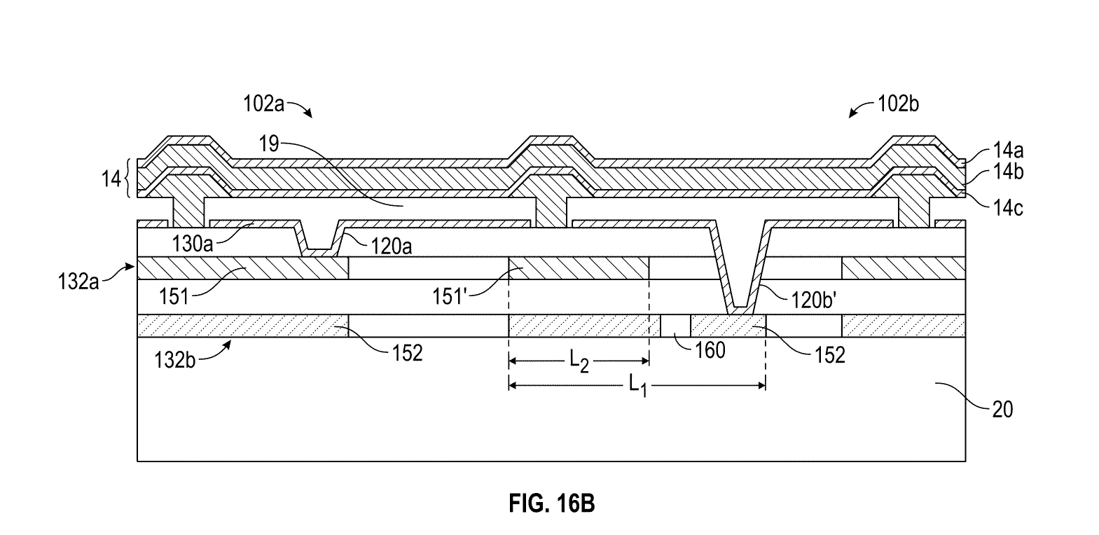

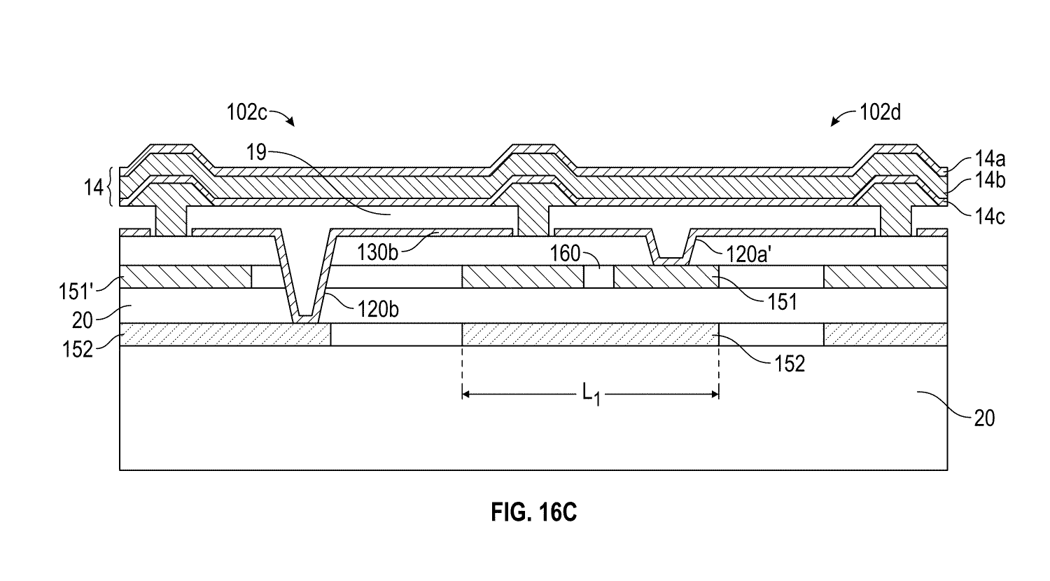

Turning to FIGS. 16A-C, another implementation for reducing visually perceptible differences caused by structural differences in the first and second interconnects is illustrated. In the implementation of FIGS. 15A-C described above, only one side of each display element contains a via 120a or 120b. In the implementation of FIGS. 16A-16C, vias 120a′ and 120b′ may be provided in these locations. Unlike the implementation of FIGS. 15A-C, though, cuts 160 may be formed through the first and second arms 151, 152 to electrically isolate these locations and vias 120a′ and 120b′ from the data lines 132a, 132b.

For example, display elements 102a, 102b may include vias 120a that provide electrical communication to the first data line 132a. These vias 120a may be formed along the top perimeter of the display element 102a and along the bottom perimeter of the adjacent display element 102b. Vias 120b′ are also formed along the bottom perimeter of the display element 102a and along the top perimeter of the adjacent display element 102b. However, the vias 120b′ are electrically isolated from the rest of the second data line 132b, because the cut line 160 separates the distal end of the second arm 152 from the second data line 132b. Therefore, the display elements 102a, 102b may still be written with data from only the first data line 132a through the vias 120a.

Similarly, in FIGS. 16A and 16C, vias 120b can be formed along the top perimeter of the display element 102c and along the bottom perimeter of the adjacent display element 102d. As above, the vias 120b provide electrical communication between the second electrodes 130b and the second data line 130b. Analogous to the vias 120b′ of FIG. 16B, FIG. 16C illustrates vias 120a′ formed along the bottom perimeter of the display element 102c and along the top perimeter of the adjacent display element 102d. At these locations, date line 132a includes the first arm 151 having the longer first length L₁. The via 120a′ is coupled between the second electrode 130b and the distal end of the first arm 151. However, as in FIG. 16B, the cut line 160 electrically isolates the via 120a′ from the first data line 132a.

By introducing the electrically isolated vias 120a′ and 120b′, structural similarities between display elements 102a, 102b, 102c, and 102d are increased.

It should be appreciated that, while the disclosed implementations illustrate two data lines and two different interconnects, more than two data lines and interconnects can be used in some implementations. For example, in some implementations, a third data line can be formed from a third layer and can electrically couple to a third segment electrode by way of a third via. There can therefore be structural differences between all three data lines. The concepts disclosed herein can be similarly applied to reduce image artifacts in displays that utilize three or more data lines.

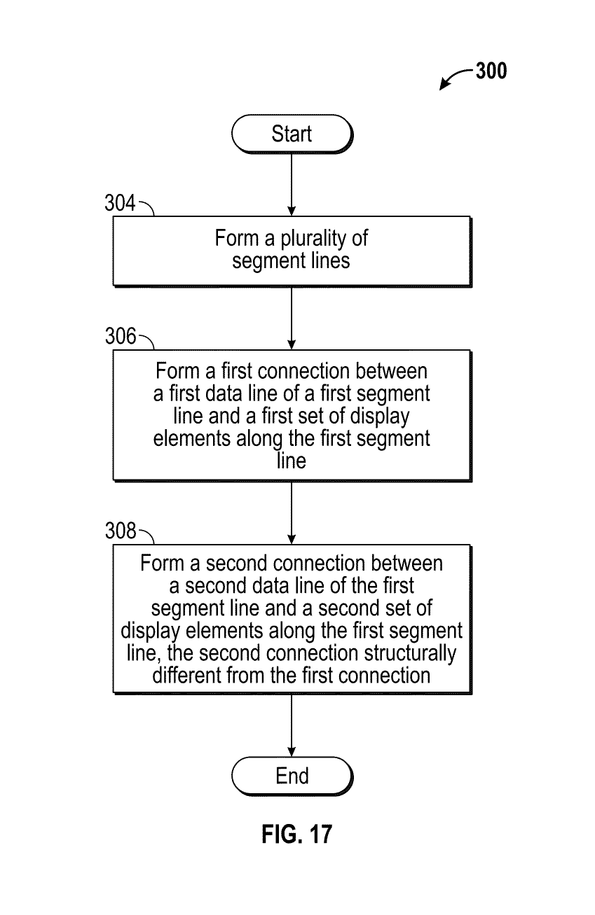

FIG. 17 is a flowchart illustrating a method 300 of manufacturing a display apparatus, according to one implementation. The method 300 can begin at a block 304 to form a plurality of segment lines. Moving to block 306, a first connection is formed between a first data line of a first segment line and a first set of display elements along the first segment line. As explained herein, the first connection can be formed by, e.g., coupling a first via to a distal end of a first arm formed in a first layer and to an electrode layer. The first arm can have a first length. From block 306, the method may transition to block 308.

Turning to block 308, a second connection can be formed between a second data line of the first segment line and a second set of display elements along the first segment line. The second connection can be formed by, e.g., coupling a second via to a second layer and to a different electrode layer. The second via can be formed beyond a distal end of a second arm formed in the first layer. The second arm can have a second length that is shorter than the first length. Further, the second connection can be structurally different from the first connection. As explained above, at least some of the structural differences can be positioned such that they do not cause substantial differences in visual appearance between display elements of the same color. At least some of the structural differences can alternate at a rate such that any differences in visual appearance are not visually resolvable by a viewer.

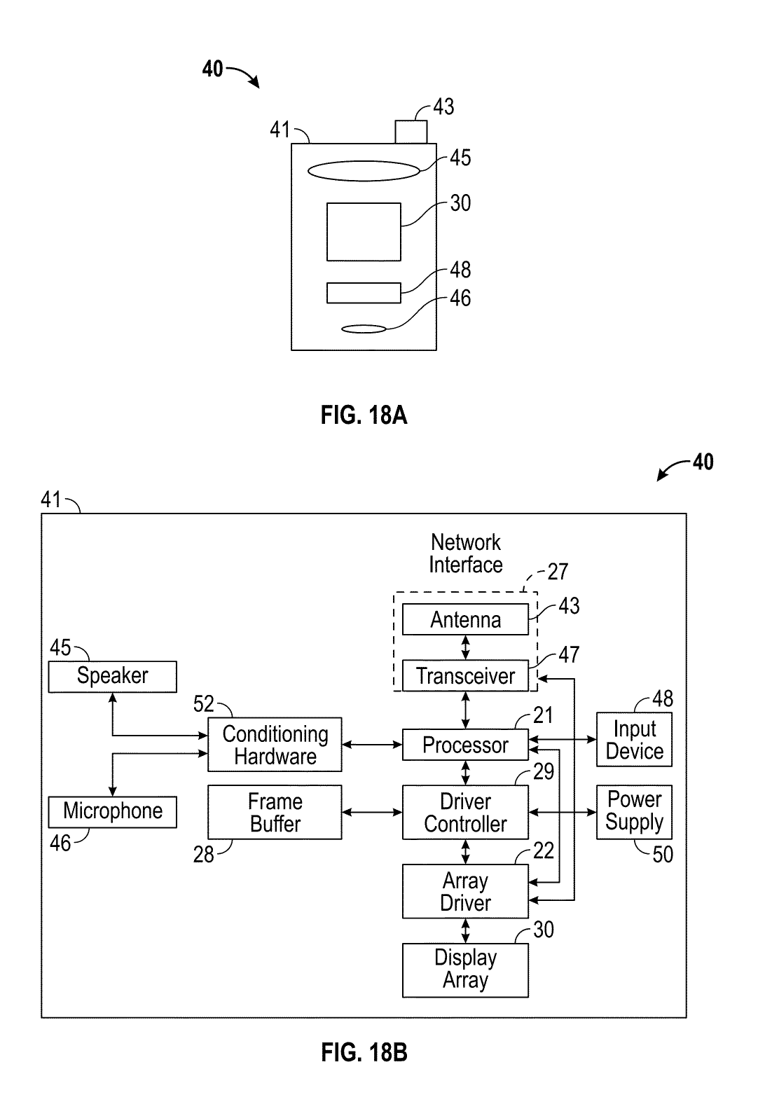

FIGS. 18A and 18B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus comprising:
a plurality of common lines;
a plurality of segment lines, wherein each segment line includes a first data line and a second data line configured to apply different data signals; and
a plurality of display elements, wherein each display element is in electrical communication with one of the plurality of common lines and one of the plurality of segment lines;
wherein the connection between the first data line of a first segment line and a first set of display elements along the first segment line is structurally different from the connection between the second data line of the first segment line and a second set of display elements along the first segment line; and
wherein at least some of the structural differences are positioned such that they do not cause substantial differences in visual appearance between display elements of the same color, or at least some of the structural differences alternate at a rate such that any differences in visual appearance are not visually resolvable by a viewer.

2. The display apparatus of claim 1, wherein the structural differences alternate between adjacent segment lines and between adjacent common lines.

3. The display apparatus of claim 1, wherein the first data line is formed from a first layer and is in electrical communication with an electrode layer through a first via, and wherein the second data line is formed from a second layer and is in electrical communication with a different electrode layer through a second via, wherein the first layer is disposed between the second layer and the electrode layers.

4. The display apparatus of claim 3, further comprising:
a first arm formed in the first layer and having a first length, wherein the first via is coupled to a distal end portion of the first arm and electrically couples the first layer to the electrode layer; and
a second arm formed in the first layer and having a second length shorter than the first length, wherein the second via is formed beyond a distal end of the second arm and electrically couples the second layer to the electrode layer.

5. The display apparatus of claim 4, the display apparatus, further comprising:
a third arm formed in the first layer adjacent to the first arm and having a third length that is substantially the same as the second length; and
a fourth arm formed in the first layer adjacent to the second arm and having a fourth length that is substantially the same as the first length.

6. The display apparatus of claim 5, wherein a via is not formed beyond a distal end of the third arm, and wherein a via is not formed in a distal end portion of the fourth arm.

7. The display apparatus of claim 5, wherein a third electrically conductive via is formed beyond a distal end of the third arm and is electrically isolated from the second data line, and wherein a fourth electrically conductive via is coupled to a distal end portion of the fourth arm and is electrically isolated from the first data line.

8. The display apparatus of claim 1, further comprising:
a first common line in electrical communication with a display element from the first set of display elements;
a second common line in electrical communication with a display element from the second set of display elements; and
driver circuitry configured to:
apply a first data signal to the first data line;
apply a second data signal to the second data line; and
simultaneously apply a write waveform to the first and second common lines.

9. The display apparatus of claim 8, wherein the first common line and the second common line are non-adjacent.

10. The display apparatus of claim 1, wherein the plurality of display elements includes one or more interferometric modulators.

11. The display apparatus of claim 1, further comprising:
a processor that is configured to communicate with the display, the processor being configured to process image data; and
a memory device that is configured to communicate with the processor.

12. The display apparatus of claim 11, further comprising a driver circuit configured to send at least one signal to the display.

13. The display apparatus of claim 12, further comprising a controller configured to send at least a portion of the image data to the driver circuit.

14. The display apparatus of claim 11, further comprising an image source module configured to send the image data to the processor.

15. The display apparatus of claim 14, wherein the image source module includes at least one of a receiver, transceiver, and transmitter.

16. The display apparatus of claim 11, the display apparatus further comprising an input device configured to receive input data and to communicate the input data to the processor.

17. A method of manufacturing a display, the method comprising:
forming a plurality of segment lines, each segment line having a first data line and a second data line configured to apply different data signals;
forming a first connection between the first data line of a first segment line and a first set of display elements along the first segment line; and
forming a second connection between the second data line of the first segment line and a second set of display elements along the first segment line, the second connection structurally different from the first connection,
wherein at least some of the structural differences are positioned such that they do not cause substantial differences in visual appearance between display elements of the same color, or at least some of the structural differences alternate at a rate such that any differences in visual appearance are not visually resolvable by a viewer.

18. The method of claim 17, the display comprising a plurality of common lines, wherein the structural differences alternate between adjacent segment lines and between adjacent common lines.

19. The method of claim 17, further comprising:
depositing a first layer to form the first data line of the first segment line;
depositing a second layer to form the second data line of the first segment line;
forming a first via and electrically coupling the first via to the first data line and an electrode layer; and
forming a second via and electrically coupling the second via to the second data line and a different electrode layer,
wherein the first layer is disposed between the second layer and the electrode layers.

20. The method of claim 19, further comprising:
forming a first arm in the first layer having a first length;
coupling the first via to a distal end portion of the first arm;
forming a second arm in the first layer having a second length shorter than the first length; and
forming the second via beyond a distal end of the second arm.

21. The method of claim 20, further comprising:
forming a third arm in the first layer adjacent to the first arm and having a third length that is substantially the same as the second length; and
forming a fourth arm in the first layer adjacent to the second arm and having a fourth length that is substantially the same as the first length.

22. A display apparatus comprising:
a plurality of common lines;
a plurality of segment lines, wherein each segment line includes a first data line and a second data line configured to apply different data signals; and
a plurality of display elements, wherein each display element is in electrical communication with one of the plurality of common lines and one of the plurality of segment lines;
first connection means for electrically connecting the first data line of a first segment line and a first set of display elements along the first segment line; and
second connection means for electrically connecting the second data line of the first segment line and a second set of display elements along the first segment line,
wherein the first connection means is structurally different from the second connection means, and
wherein at least some of the structural differences are positioned such that they do not cause substantial differences in visual appearance between display elements of the same color, or at least some of the structural differences alternate at a rate such that any differences in visual appearance are not visually resolvable by a viewer.

23. The display apparatus of claim 22, wherein the structural differences alternate between adjacent segment lines and common lines.

24. The display apparatus of claim 22, wherein the first data line is formed from a first layer and is in electrical communication with an electrode layer through the first connection means, and wherein the second data line is formed from a second layer and is in electrical communication with a different electrode layer through the second connection means, wherein the first layer is disposed between the second layer and the electrode layers.

25. The display apparatus of claim 24, wherein:
the first connection means includes:
a first arm formed in the first layer and having a first length; and
a first electrically conductive via coupled to a distal end portion of the first arm and electrically coupling the first layer with the electrode layer; and
the second connection means includes:
a second arm formed in the first layer and having a second length shorter than the first length; and
a second electrically conductive via formed beyond a distal end of the second arm and electrically coupling the second layer with the electrode layer.

26. The display apparatus of claim 25, the display apparatus further comprising:
a third connection means adjacent the first connection means, wherein the third connection means includes a third arm formed in the first layer and having a third length that is substantially the same as the second length; and
a fourth connection means adjacent the second connection means, wherein the fourth connection means includes a fourth arm formed in the first layer and having a fourth length that is substantially the same as the first length.

27. The display apparatus of claim 26, wherein an electrically conductive via is not formed beyond a distal end of the third arm, and wherein an electrically conductive via is not formed in a distal end of the fourth arm.

28. The display apparatus of claim 22, wherein the plurality of display elements includes one or more interferometric modulators.
